(19) United States
(12) Patent Application Publication
(10) Pub. No.: US 2011/0305472 A1
(43) Pub. Date: Dec. 15, 2011

(54) IMAGE FORMING APPARATUS AND IMAGE FORMING METHOD

(75) Inventor: Yoshiaki Okano, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/118,833

(22) Filed: May 31, 2011

Related U.S. Application Data
(60) Provisional application No. 61/352,958, filed on Jun. 9, 2010.

(51) Int. Cl. G03G 15/16; G03G 15/01

(52) U.S. Cl. 399/66; 399/302

(57) ABSTRACT

According to one embodiment, an image forming apparatus includes plural image forming sections provided along an intermediate transfer member, and a controller configured to sequentially transfer, with primary transfer members of the image forming sections, images of respective colors onto the intermediate transfer member to be superimposed one on top of another to form a color image and continue to apply, until an exposing device of the image forming section at a final stage finishes formation of a latent image, a voltage to the primary transfer member of at least one image forming section among the image forming sections other than the image forming section at the final stage.

### CROSS-REFERENCE TO RELATED APPLICATIONS

This application is based upon and claims the benefit of U.S. Provisional Application No. 61/352,958, filed on Jun. 9, 2010; the entire contents of which are incorporated herein by reference.

### FIELD

Embodiments described herein relate generally to an image forming apparatus and an image forming method.

### BACKGROUND

In the past, an image forming apparatus of a quadruple tandem system is known as a color image forming apparatus of an electrophotographic system.

In the image forming apparatus of this type, plural image forming sections including photoconductive members, charging means, developing means, and cleaning means are provided along an intermediate transfer belt. The image forming sections sequentially transfer images of colors of yellow, magenta, cyan, and black onto the intermediate transfer belt to be superimpose one on top of another and form a color image obtained by superimposing the four colors one on top of another on the intermediate transfer belt. The color image is collectively transferred from the intermediate transfer belt onto recording paper by a secondary transfer roller and thereafter fixed by fixing means.

In the image forming apparatus of this type, it is pointed out that, if thick paper is used as the recording paper, a blur occurs in a printed image.

### BRIEF DESCRIPTION OF THE DRAWINGS

FIG. 1 is an exemplary schematic diagram of an image forming apparatus according to a first embodiment;

FIG. 2 is an exemplary schematic diagram of an image blur that occurs in an image forming apparatus in the past;

FIG. 3 is an exemplary time chart of driving signals and control signals of the image forming apparatus during the occurrence of the image blur;

FIG. 4 is an exemplary time chart of driving signals and control signals of the image forming apparatus according to the first embodiment;

FIG. 5 is an exemplary time chart of driving signals and control signals of an image forming apparatus according to a second embodiment; and

FIG. 6 is an exemplary time chart of driving signals and control signals of an image forming apparatus according to a third embodiment.

### DETAILED DESCRIPTION

In general, according to one embodiment, an image forming apparatus includes: plural image forming sections provided along an intermediate transfer member, the image forming sections including: image bearing members, surfaces of which are charged to predetermined potential; exposing devices configured to expose the surfaces of the image bearing members to light and form latent images on the surfaces; developing devices configured to develop toner images on the latent images formed on the surfaces of the image bearing members; and primary transfer members configured to come into contact with the toner images, which are developed on the image bearing members, via the intermediate transfer member and transfer the toner images onto the intermediate transfer member using transfer bias voltages applied to the primary transfer members; and a controller configured to sequentially transfer, with the primary transfer members, images of respective colors onto the intermediate transfer member to be superimposed one on top of another to form a color image and continue to apply, until the exposing device of the image forming section at a final stage finishes formation of the latent image, a voltage to the primary transfer member of at least one image forming section among the image forming sections other than the image forming section at the final stage.

### First Embodiment

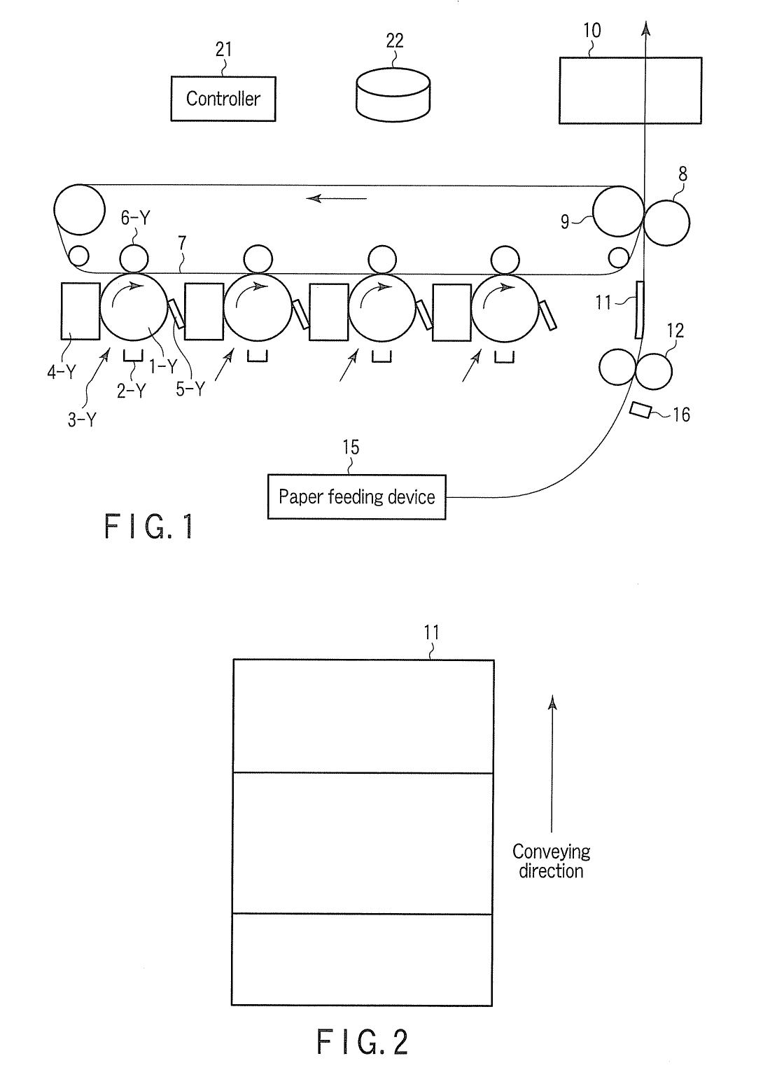

FIG. 1 is an exemplary schematic diagram of an image forming apparatus 100 according to a first embodiment. The image forming apparatus 100 is a color copying machine of a quadruple tandem system.

In the image forming apparatus 100, a yellow station Y, a magenta station M, a cyan station C, and a black station K are provided. The stations respectively include photoconductive members 1-Y, 1-M, 1-C, and 1-K, which are image bearing members, and form toner images of respective colors on the photoconductive members.

The yellow station Y is explained. An outer circumferential surface of the photoconductive member 1-Y rotating in an arrow direction in the figure is charged by a charging device 2-Y. The charging device 2-Y uniformly charges the photoconductive member 1-Y to a negative voltage. A not-shown exposing device irradiates a laser 3-Y corresponding to an image, which should be recorded, on the photoconductive member 1-Y. An electrostatic latent image is formed on the exposed photoconductive member 1-Y.

A developing device 4-Y forms a development field between the developing device 4-Y and the photoconductive member 1-Y using a development bias voltage. The developing device 4-Y negatively charges a developer including a yellow toner stored therein. The negatively-charged developer adheres to the photoconductive member 1-Y according to a potential of a region of the electrostatic latent image formed on the photoconductive member 1-Y. A reversal image is visualized as a yellow toner image.

A primary transfer roller 6-Y is a roll formed of conductive foamed urethane. During image formation, the primary transfer roller 6-Y is pressed against the photoconductive member 1-Y via an intermediate transfer belt 7 by springs provided on both sides of a roller shaft.

A Y primary transfer bias voltage of about +1000 V is applied to the primary transfer roller 6-Y. In a transfer region of the yellow station Y formed by the intermediate transfer belt 7, the primary transfer roller 6-Y, and the photoconductive member 1-Y, the yellow toner image on the photoconductive member 1-Y is transferred onto the intermediate transfer belt 7 by an action of the Y primary transfer bias voltage. A transfer residual toner remaining on the photoconductive member 1-Y without being transferred is cleaned by a photoconductive member cleaner 5-Y. Thereafter, the photoconductive member 1-Y is charged by the charging device 2-Y and repeats the operation explained above.

Similarly, in the magenta station M, a magenta toner image is visualized. In the cyan station C, a cyan toner image is visualized. In the black station K, a black toner image is visualized. The intermediate transfer belt 7 having the yellow toner image transferred thereon is sequentially conveyed to transfer regions of the stations for the respective colors and the magenta toner image, the cyan toner image, and the black toner image are transferred onto the intermediate transfer belt 7.

On the other hand, a recording paper 11 fed from a paper feeding device 15 is conveyed on a conveying path. A media sensor 16 detects characteristics of the recording paper 11. The characteristics of the recording paper 11 are paper thickness, paper basis weight, and the like. In this embodiment, the media sensor 16 detects the paper thickness. The recording paper 11 is conveyed in synchronization with a conveying operation of the intermediate transfer belt 7 after being put on standby before a registration roller 12.

The recording paper 11 is delivered to a secondary transfer region, which is formed by the intermediate transfer belt 7, a secondary transfer roller 8, and a counter roller 9, by the registration roller 12 in synchronization with the toner images on the intermediate transfer belt 7 being carried. A transfer bias voltage is applied to the secondary transfer roller 8. In the secondary transfer region, the yellow, magenta, cyan, and black toner images formed on the intermediate transfer belt 7 are transferred onto the recording paper 11 by an action of a transfer field formed by the transfer bias voltage.

The recording paper 11 having the toners of the respective colors transferred thereon is conveyed to a fixing device 10. In the fixing device 10, heat and pressure are applied to the recording paper 11, the toners on the recording paper 11 melt, and fixing is performed. Residual toners remaining on the intermediate transfer belt 7 without being transferred onto the recording paper 11 are cleaned by a not-shown cleaner.

The image forming apparatus 100 includes a controller 21 and a MEMORY 22. The controller 21 collectively controls various kinds of processing in the image forming apparatus 100. The controller 21 executes computer programs stored in the MEMORY 22 to thereby realize various functions of the image forming apparatus 100. The MEMORY 22 includes a ROM and a RAM and stores various kinds of information used in the image forming apparatus 100 besides the computer programs.

An image blur is explained below.

FIG. 2 is an exemplary schematic diagram of an image blur that occurs in the image forming apparatus 100 in the past.

On the recording paper 11, streak-like regions are formed in a direction orthogonal to a conveying direction. The density of the streak-like regions is different from the density of regions adjacent to the streak-like regions. The streak-like regions are formed in two places on the recording paper 11. A space between the streak-like regions is not always the same value. The image blur occurs when the recording paper 11 is thick paper and does not occur when the thickness of the recording paper 11 is equal to or smaller than a predetermined value.

A cause of the image blur is explained below.

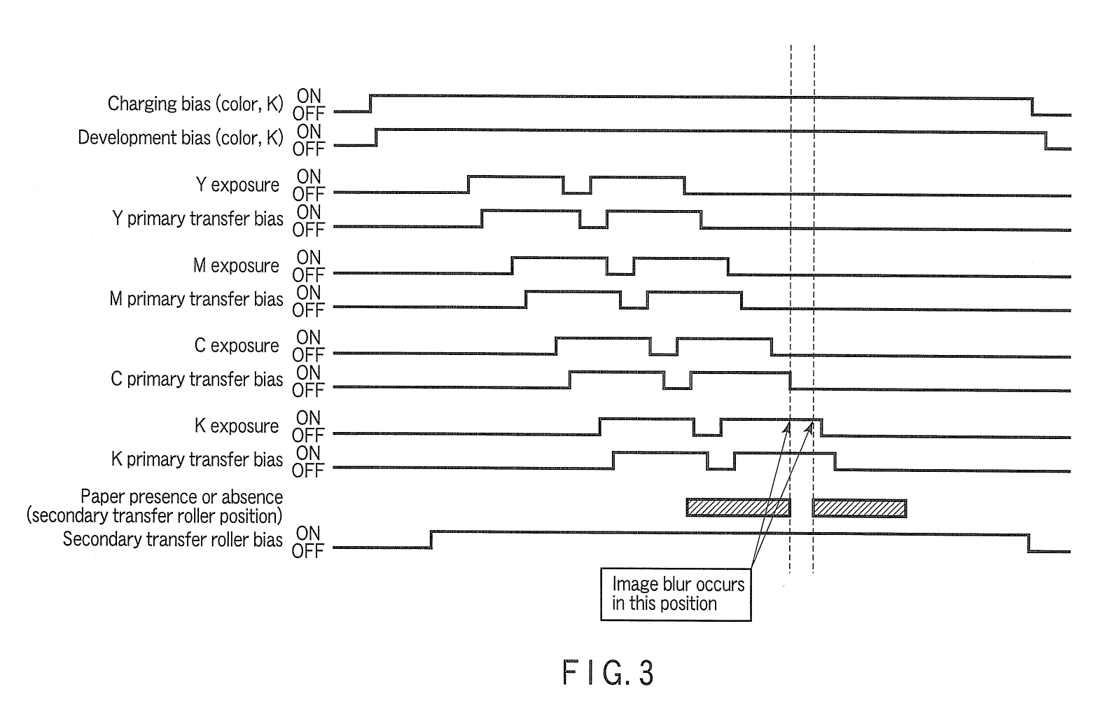

FIG. 3 is an exemplary time chart of driving signals and control signals of the image forming apparatus 100 during occurrence of the image blur. In the time chart, the number of pieces of recording paper is two. An image forming operation is explained below with reference to FIG. 3.

When printing is started, charging bias voltages are applied by charging devices 2-Y, 2-M, 2-C, and 2-K and development bias voltages are applied by developing devices 4-Y, 4-M, 4-C, and 4-K. A secondary transfer bias voltage is applied to the secondary transfer roller 8.

The exposing device irradiates the laser 3-Y corresponding to a first image on the photoconductive member 1-Y. An electrostatic latent image is formed on the exposed photoconductive member 1-Y. The developing device 4-Y generates a development bias voltage and visualizes a yellow toner image on the photoconductive member 1-Y. The yellow toner image on the photoconductive member 1-Y is transferred onto the intermediate transfer belt 7 by the Y primary transfer bias voltage applied to the primary transfer roller 6-Y. This operation is sequentially executed in the stations for the respective colors with a delay equivalent to a distance among the stations.

On the other hand, as the laser 3-Y, when a predetermined time elapses after the exposing device irradiates exposure light corresponding to the first image on the photoconductive member 1-Y, the exposing device irradiates exposure light corresponding to a second image on the photoconductive member 1-Y. Thereafter, the same operation is sequentially executed in the stations for the respective colors.

In FIG. 3, timing when the recording paper 11 is subjected to secondary transfer by the secondary transfer roller 8 in this sequence is indicated by a thick bar.

The secondary transfer roller 8 is arranged to freely come into contact with and separate from a belt surface of the intermediate transfer belt 7. The recording paper 11 conveyed to the secondary transfer roller 8 is pressed against the belt surface in a predetermined secondary transfer position (nip region) by the secondary transfer roller 8 and a toner image is transferred onto the recording paper 11. Therefore, the speed of the intermediate transfer belt 7 fluctuates when the recording paper 11 is conveyed and rushes into the nip region for the secondary transfer. Similarly, the speed of the intermediate transfer belt 7 fluctuates when a trailing end of the recording paper 11 passes through the nip region for the secondary transfer.

Since the speed of the intermediate transfer belt 7 fluctuates, the rotating speed of the photoconductive members is affected. In the time chart of FIG. 3, a blur occurs at an exposure point of the black station K that performs formation of the second image. In other words, a space among halftone images written on the photoconductive members fluctuates. The blur is considered to occur in images as a result of the fluctuation in the space.

As shown in FIG. 2, certainty of this estimation is supported by the appearance of the image blur as streak-like regions and the formation of the streak-like regions in the two places on the recording paper 11.

A method of preventing an image blur is explained below.

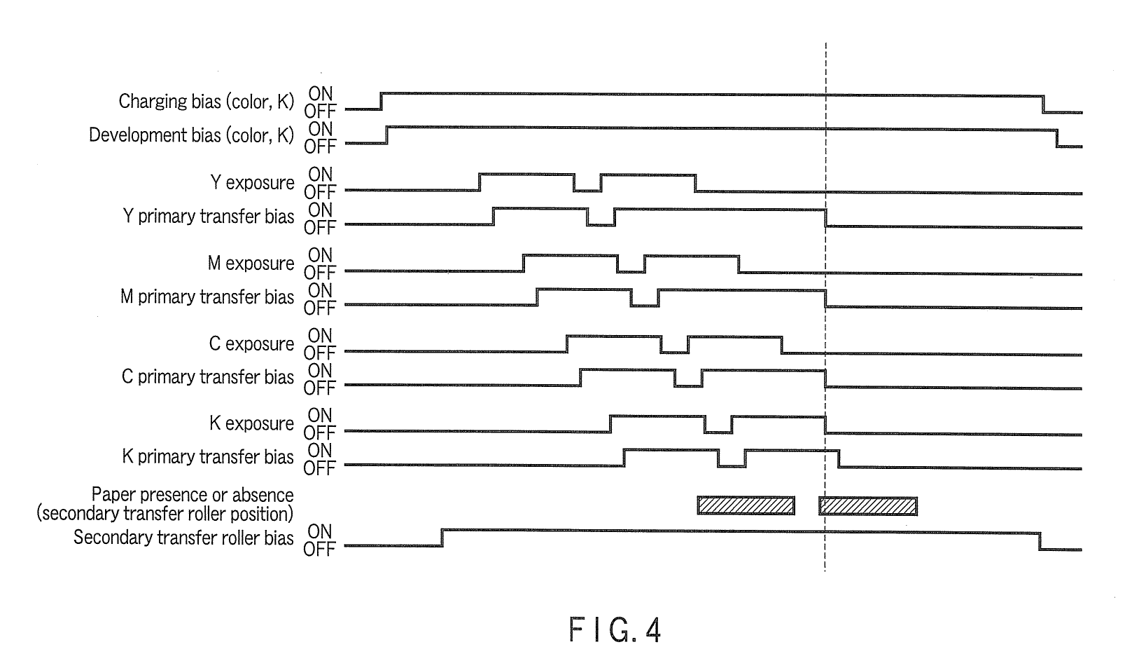

FIG. 4 is an exemplary time chart of driving signals and control signals of the image forming apparatus 100 according to the first embodiment. In the time chart of FIG. 4, as in the time chart of FIG. 3, the number of pieces of recording paper to be printed is two.

First, charging bias voltages and development bias voltages of the color stations (yellow, magenta, and cyan) and the black station are sequentially turned on. Subsequently, in the yellow station Y, Y exposure light (the laser 3-Y) is turned on according to first image data. The primary transfer roller 6-Y turns on the Y primary transfer bias voltage in synchronization with a yellow toner image formed on the photoconductive member 1-Y and transfers the yellow toner image onto the intermediate transfer belt 7. In the magenta station M, the cyan station C, and the black station K, the same operation is performed with a delay equivalent to a distance of a pitch among the photoconductive members.

The same operation is performed for the second image. The Y primary transfer bias voltage of the yellow station Y, an M primary transfer bias voltage of the magenta station M, and a C primary transfer bias voltage of the cyan station C continue to be on at least until K exposure for the second image by the black station K ends.

In this way, even if exposure of the color stations (yellow, magenta, and cyan) ends concerning an image of a final page, the primary transfer bias voltages of the stations are maintained in an ON state until the K exposure of the black station K ends.

When the primary transfer bias voltages are applied to the primary transfer rollers 6, electrostatic attraction force is generated between the primary transfer rollers 6 and the photoconductive members 1. The primary transfer bias voltages applied to the primary transfer rollers 6 are +1000 volts to +2000 volts and the voltage applied to the photoconductive members 1 is − several hundred volts. Therefore, during transfer, attraction force by Coulomb force is generated between the primary transfer rollers 6 and the photoconductive members 1 separately from the pressing force by the springs.

Specifically, the primary transfer bias voltages are maintained in the ON state, whereby the photoconductive members 1-Y, 1-M, and 1-C of the respective stations are attracted to the primary transfer rollers 6-Y, 6-M, and 6-C via the intermediate transfer belt 7. As a result, even when thick paper rushes into the nip region for the secondary transfer or when the thick paper passes through the nip region, the intermediate transfer belt 7 is less easily affected. In other words, it is possible to prevent an image blur due to speed fluctuation of the intermediate transfer belt 7.

The effect of the prevention of an image blur realized by maintaining the ON state of the primary transfer bias voltage can also be recognized from, for example, the fact that an image blur does not occur in the first recording paper 11 in the time chart in the past of FIG. 3.

For example, when a leading end of the first thick paper rushes into the nip region for the secondary transfer in FIG. 3, the K exposure for the first image is being performed. However, at this point, at least the Y primary transfer bias voltage of the yellow station Y and the M primary transfer bias voltage of the magenta station M are in the ON state. Therefore, as explained above, it is considered that the speed fluctuation of the intermediate transfer belt 7 is suppressed and occurrence of an image blur is prevented.

However, if the image forming apparatus 100 prints only one piece of recording paper rather than printing plural pieces of recording paper, when a leading end of first recording paper rushes into the nip region for the secondary transfer, the primary transfer bias voltages other than the K primary transfer bias voltage are off. Therefore, the primary transfer bias voltage needs to maintain the ON state until the K exposure ends.

As explained above, an image blur is caused by the speed fluctuation of the intermediate transfer belt at the point when thick paper rushes into or passes through the nip region for the secondary transfer. Therefore, the operation shown in FIG. 4 only has to be carried out if the recording paper 11 is the thick paper. This operation does not have to be carried out if the recording paper 11 is other than the thick paper.

The image forming apparatus 100 has an automatic mode for automatically selecting a classification of a sheet (e.g., thick paper or plain paper) on the basis of paper thickness information detected by the media sensor 16 and a manual mode in which a user selects a classification of a sheet from an operation panel in advance. In the embodiment explained above, it is possible to change operation according to a sheet classification selected in the automatic mode or the manual mode.

A characteristic of the sheet detected by the media sensor 16 is not limited to the paper thickness and may be basis weight. The characteristic of the sheet detected by the media sensor 16 does not have to be the paper thickness or the basis weight. For example, the media sensor 16 may detect the resistance or the light transmission property of the sheet and acquire paper thickness or basis weight on the basis of a value obtained by the detection.

### Second Embodiment

In a second embodiment, a method of turning on a primary transfer bias voltage is different from that in the first embodiment. Components same as those in the first embodiment are denoted by the same reference numerals and signs and detailed explanation of the components is omitted.

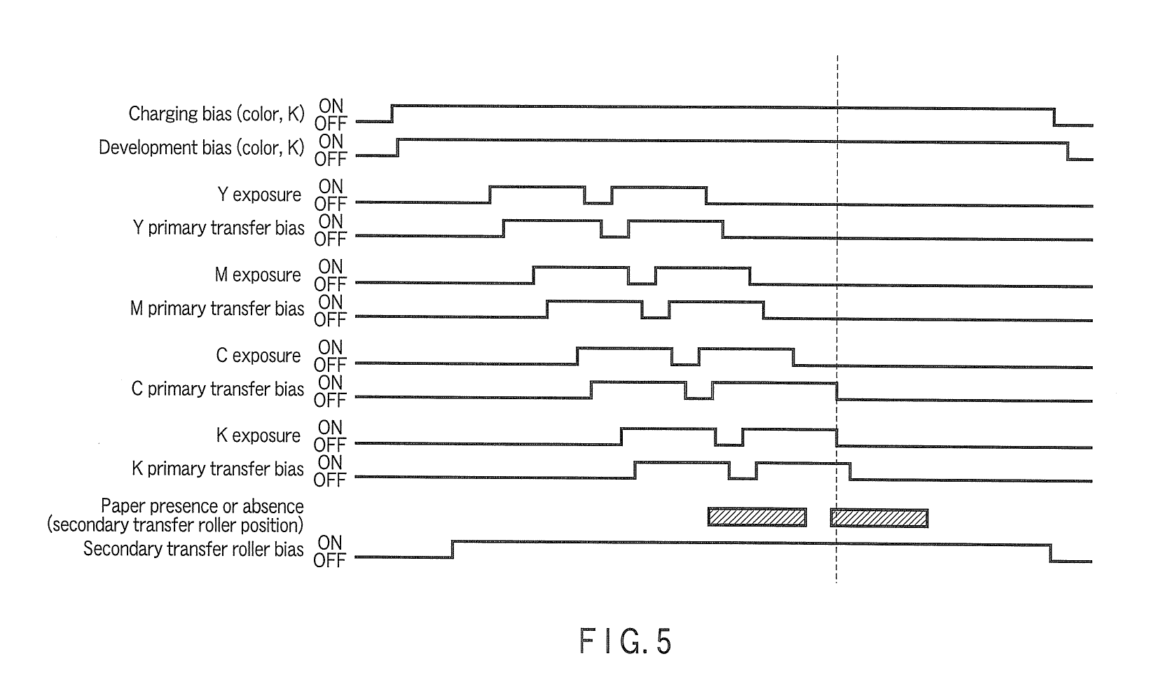

FIG. 5 is an exemplary time chart of driving signals and control signals of the image forming apparatus 100 according to the second embodiment. In the time chart shown in FIG. 5, as in the time chart shown in FIG. 4, the number of pieces of recording paper to be printed is two.

In the second embodiment, instead of turning on primary transfer bias voltages of all stations, a primary transfer bias voltage of at least one station among stations other than the black station K is turned on.

In the time chart of FIG. 5, only the C primary transfer bias voltage of the cyan station C is maintained in an ON state until K exposure for a second image of the black station K ends. The Y primary transfer bias voltage of the yellow station Y or the M primary transfer bias voltage of the magenta station M may be maintained in the ON state until at least the K exposure for the second image of the black station K ends. Primary transfer bias voltages of arbitrary two stations among the yellow station Y, the magenta station M, and the cyan station C may be maintained in the ON state until the K exposure for the second image of the black station K ends.

In the second embodiment, it is possible to suppress consumption of primary transfer bias voltages for preventing an image blur.

### Third Embodiment

A third embodiment is different from the first embodiment in a method of turning on primary transfer bias voltages. Therefore, components same as those in the first embodiment are denoted by the same reference numerals and signs and detailed explanation of the components is omitted.

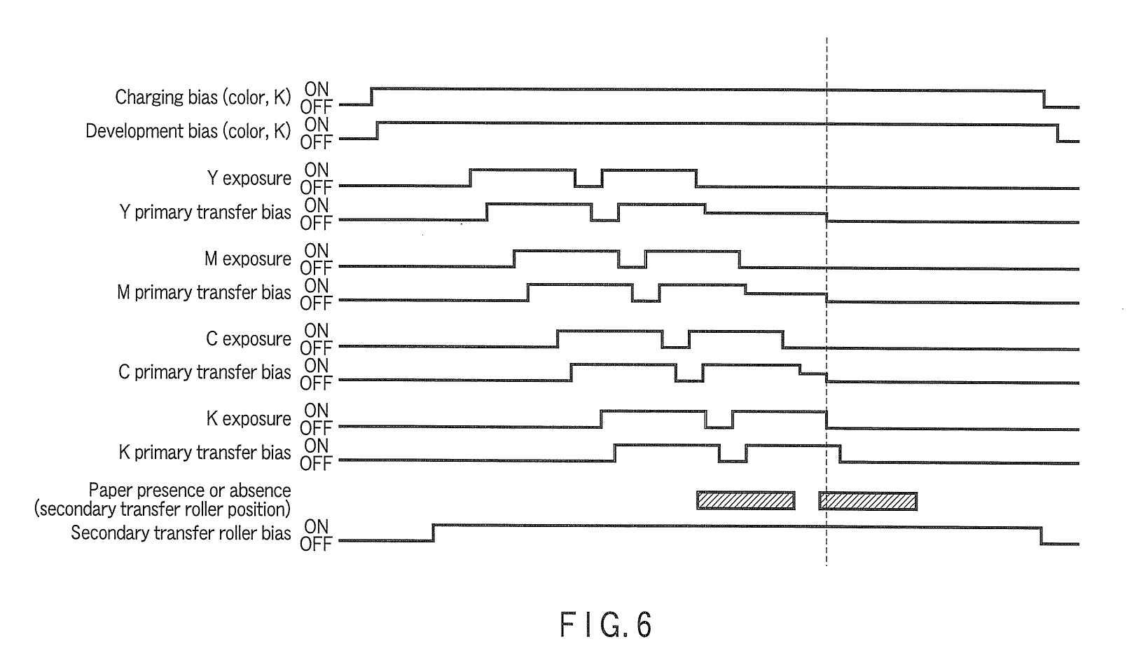

FIG. 6 is an exemplary time chart of driving signals and control signals of the image forming apparatus 100 according to the third embodiment. In the time chart of FIG. 6, as in the time chart of FIG. 4, the number of pieces of recording paper to be printed is two.

In the third embodiment, primary transfer bias voltages applied to stations to prevent an image blur are set lower than primary transfer bias voltages applied to the stations to perform primary transfer. Consequently, it is possible to reduce an image blur while maintaining attraction force between the primary transfer rollers 6 and the photoconductive members 1.

In the third embodiment, it is possible to suppress consumption of the primary transfer bias voltages for preventing an image blur.

As explained in the second embodiment, instead of turning on the primary transfer bias voltages of all the stations, a primary transfer bias voltage of at least one station among the stations other than the black station K may be turned on.

As explained in the first to third embodiments, concerning an image of a final page, it is possible to prevent an image blur by continuing to apply a voltage to a primary transfer member of at least one image forming section among the image forming sections (the station Y, the station M, and the station C) other than the final image forming section (the station K) until at least an image forming operation of an exposing section (the photoconductive member 1-K) of the final image forming section ends.

The controller 21 collectively controls the operations in the first to third embodiments of the image forming apparatus 100.

The functions explained in the embodiment may be configured using hardware or may be realized by causing a computer to read computer programs that describe the functions using software. The functions may be configured by selecting the software or the hardware as appropriate.

Further, the functions can also be realized by causing the computer to read computer programs stored in a not-shown recording medium. A recording format of the recording medium in the embodiments may be any form as long as the recording medium can record the computer programs and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
plural image forming sections provided along an intermediate transfer member, the image forming sections including: image bearing members, surfaces of which are charged to predetermined potential; exposing devices configured to expose the surfaces of the image bearing members to light and form latent images on the surfaces; developing devices configured to develop toner images on the latent images formed on the surfaces of the image bearing members; and primary transfer members configured to come into contact with the toner images, which are developed on the image bearing members, via the intermediate transfer member and transfer the toner images onto the intermediate transfer member using a transfer bias voltage applied to the primary transfer members; and
a controller configured to sequentially transfer, with the primary transfer members, images of respective colors onto the intermediate transfer member to be superimposed one on top of another to form a color image and continue to apply, until the exposing device of the image forming section at a final stage finishes formation of a latent image, a voltage to the primary transfer member of at least one image forming section among the image forming sections other than the image forming section at the final stage.

2. The apparatus according to claim 1, wherein the voltages continuing to be applied to the primary transfer members are the transfer bias voltages applied to the primary transfer members by the image forming sections during image formation.

3. The apparatus according to claim 1, wherein the voltages continuing to be applied to the primary transfer members are voltages lower than the transfer bias voltages applied to the primary transfer members by the image forming sections during image formation.

4. The apparatus according to claim 1, wherein, if thickness of recording paper onto which the formed color image is transferred is equal to or larger than a predetermined value, the controller continues to apply a voltage to the primary transfer member of at least one image forming section among the image forming sections other than the image forming section at the final stage until at least the exposing device of the image forming section at the final stage finishes formation of the latent image.

5. The apparatus according to claim 4, further comprising a media sensor configured to detect a characteristic of the recording paper, wherein
the controller determines the thickness of the recording paper on the basis of a value detected by the media sensor.

6. The apparatus according to claim 5, further comprising an operation input section for inputting information concerning the recording paper, wherein
the controller determines the thickness of the recording paper on the basis of the information input from the operation input section.

7. The apparatus according to claim 4, wherein, if the thickness of the recording paper onto which the formed color image is transferred is smaller than the predetermined value, the controller finishes each application of the voltage after each primary transfer member of the image forming section transfers the toner image onto the intermediate transfer member.

8. The apparatus according to claim 7, further comprising a media sensor configured to detect a characteristic of the recording paper, wherein
the controller determines the thickness of the recording paper on the basis of a value detected by the media sensor.

9. The apparatus according to claim 7, further comprising an operation input section for inputting information concerning the recording paper, wherein
the controller determines the thickness of the recording paper on the basis of the information input from the operation input section.

10. The apparatus according to claim 1, wherein it is when a color image of a final page is formed that the controller continues to apply, until the exposing device of the image forming section at the final stage finishes formation of the latent image, the voltage to the primary transfer member of at least one image forming section among the image forming sections other than the image forming section at the final stage.

11. An image forming method for an image forming apparatus including plural image forming sections provided along an intermediate transfer member, the image forming sections including: image bearing members, surfaces of which are charged to predetermined potential; exposing devices configured to expose the surfaces of the image bearing members to light and form latent images on the surfaces; developing devices configured to develop toner images on the latent images formed on the surfaces of the image bearing members; and primary transfer members configured to come into contact with the toner images, which are developed on the image bearing members, via the intermediate transfer member and transfer the toner images onto the intermediate transfer member using a transfer bias voltage applied to the primary transfer members,
the method comprising:
sequentially transferring, with the primary transfer members, images of respective colors onto the intermediate transfer member to be superimposed one on top of another to form a color image; and
continuing to apply, until the exposing device of the image forming section at a final stage finishes formation of a latent image, a voltage to the primary transfer member of at least one image forming section among the image forming sections other than the image forming section at the final stage.

12. The method according to claim 11, wherein the voltages continuing to be applied to the primary transfer members are the transfer bias voltages applied to the primary transfer members by the image forming sections during image formation.

13. The method according to claim 11, wherein the voltages continuing to be applied to the primary transfer members are voltages lower than the transfer bias voltages applied to the primary transfer members by the image forming sections during image formation.

14. The method according to claim 11, further comprising, if thickness of recording paper onto which the formed color image is transferred is equal to or larger than a predetermined value, continuing to apply a voltage to the primary transfer member of at least one image forming section among the image forming sections other than the image forming section at the final stage until at least the exposing device of the image forming section at the final stage finishes formation of the latent image.

15. The method according to claim 14, further comprising determining the thickness of the recording paper on the basis of a value detected by a media sensor configured to detect a characteristic of the recording paper.

16. The method according to claim 14, further comprising determining the thickness of the recording paper on the basis of information concerning the recording paper input from an operation input section for inputting the information.

17. The method according to claim 14, further comprising, if the thickness of the recording paper onto which the formed color image is transferred is smaller than the predetermined value, finishing each application of the voltage after each primary transfer member of the image forming section transfers the toner image onto the intermediate transfer member.

18. The method according to claim 17, further comprising determining the thickness of the recording paper on the basis of a value detected by a media sensor configured to detect a characteristic of the recording paper.

19. The method according to claim 17, further comprising determining the thickness of the recording paper on the basis of information concerning the recording paper input from an operation input section for inputting the information.

20. The method according to claim 11, wherein it is when a color image of a final page is formed that, until the exposing device of the image forming section at the final stage finishes formation of the latent image, a voltage continues to be applied to the primary transfer member of at least one image forming section among the image forming sections other than the image forming section at the final stage.
